(19) United States
(12) Patent Application Publication
(10) Pub. No.: US 2007/0247656 A1
(43) Pub. Date: Oct. 25, 2007

(54) Document production workflow cost estimation system

(75) Inventors: Daniel W. Manchala, Torrance, CA (US); May G. Onaga, Cypress, CA (US); Aillil I. Halsema, Los Angeles, CA (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/408,842

(22) Filed: Apr. 21, 2006

(51) Int. Cl. G06F 3/12

(52) U.S. Cl. 358/1.15

(57) ABSTRACT

Methods are disclosed that include receiving information regarding a print order, generating a plurality of possible workflows to complete the print order, determining what materials and resources will be required to complete the print order, estimating a cost for completing the print order for each workflow including estimating costs for shipping some or all of the print job based upon the materials and resources to be used, and choosing a workflow to use to complete the print order based at least in part upon the estimated cost for each workflow. Methods also include providing the estimated cost of completing a print job to the generator of the print order, submitting a bid based upon the estimated cost, and selecting a printing organization based upon the bids received.

The embodiments disclosed herein are directed toward production printing and more specifically to improved cost estimation techniques for estimating costs of production workflows and submitting bids based upon such estimates.

Production printing encompasses a variety of services and often requires use of multiple devices. Output can be printed on a variety of media, and can be bound, laminated, etc. Sometimes, a printer will have printing facilities located in multiple locations, and different facilities will have different production capabilities or capacities. Where the finished product is generated may call for a decision on the part of the publisher.

Further, today's Print-On-Demand (POD) allows a publisher to reduce costs by minimizing waste, such as by allowing the required number of copies to be printed only when needed. At the same time, it allows the publisher to update the content with the latest available information. Sometimes, scanned versions of out-of-print books are also made available to be printed when a request comes from a certain consumer.

Further benefits of POD can be reaped by allowing the print publisher to choose the location of the print facility from where the final product will be shipped out, by combining it with another concept called Distribute-then-Print (DTP). This will allow a print publisher to hasten the due date by eliminating the time required to ship a printed product from a central print facility to a major hub or city.

Customers will usually obtain one or more cost estimates before choosing production printing organization, especially when the order is large. Publishers typically use some sort of pre-flight software to calculate these cost estimates based upon the media and marking material to be used.

It would be useful if these estimates included shipping or delivery costs. In many cases, the customer does not have an accurate way to estimate the delivery or shipping costs before submitting a print order. After an order is completed, the resulting letter or package is weighed to determine the delivery or shipping costs using a certain delivery service's rates. These initial estimates would be more accurate if the costs are based upon the size and/or weight of the completed job.

Further, because materials and/or resources for a print job may not be present at one location, the cost of moving materials or resources from one site to another will also affect the final cost of a document and multiple locations may exist for where the final output may be generated. Therefore, it would be useful to a production printing company to include these factors in its cost estimates and when choosing a workflow.

Sometimes, people will order documents such as books, journals, etc., from companies. These documents may be printed on demand, thereby triggering the same issues with respect to costs.

Embodiments encompass a method that includes receiving information regarding a print order, generating a plurality of possible workflows to complete the print order, determining what materials and resources will be required to complete the print order, estimating a cost for completing the print order for each workflow including estimating costs for shipping some or all of the print job based upon the materials and resources to be used, and choosing a workflow to use to complete the print order based at least in part upon the estimated cost for each workflow.

Embodiments also encompass a method for generating a bid for a print job. The method includes receiving the details of a job to be printed, generating a plurality of possible workflows to complete the print order, determining the costs of each of the possible workflows, and submitting a bid for the print job based upon a cost of the cheapest of the plurality of possible workflows. Determining the cost of each workflow includes determining the costs of shipping materials between production sites as well as shipping a finished product.

Various exemplary embodiments will be described in detail, with reference to the following figures.

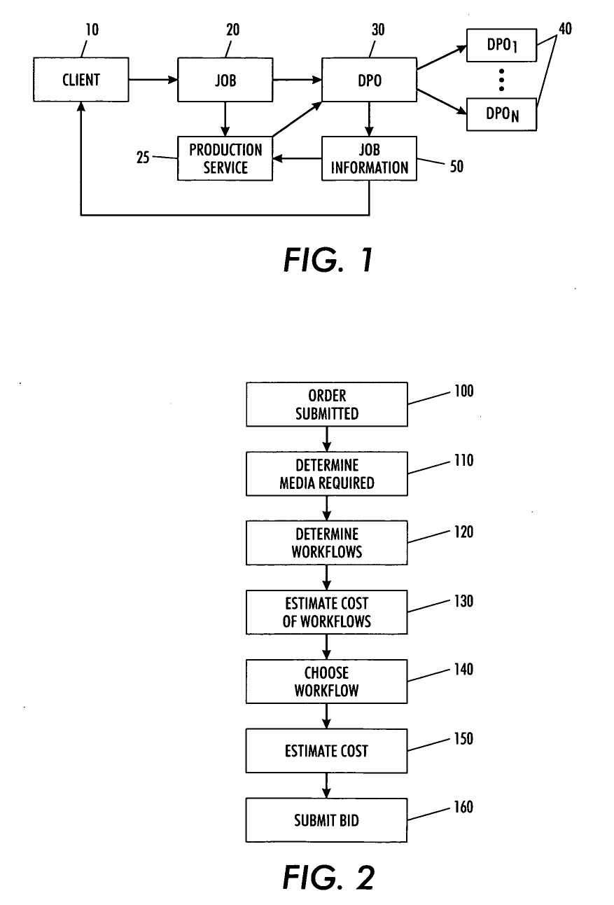

FIG. 1 is a schematic drawing of the components of an exemplary publishing process.

FIG. 2 is a flow chart of an exemplary cost estimation process performed by the recipient(s) of a document production request.

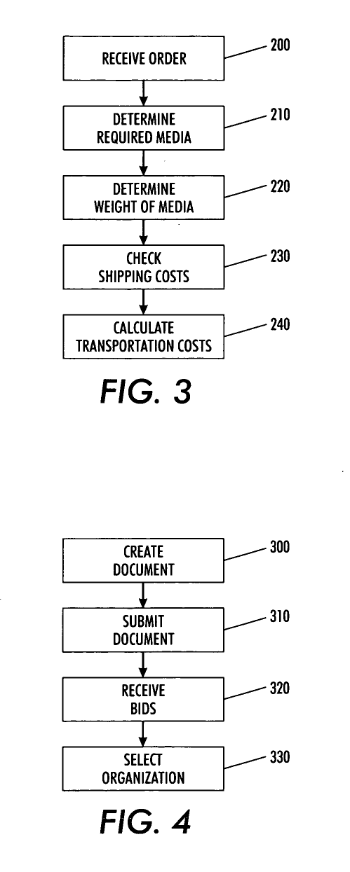

FIG. 3 is a flow chart of an exemplary method for determining the shipping costs for a particular workflow.

FIG. 4 is a flow chart of an exemplary method of soliciting bids from document production services.

A printing device as used herein refers to any device that produces visible marks on paper. Printing devices include, for example, copiers, printers, or multi-function devices. Paper as used herein refers to any markable media such as, for example, paper, plastic, and textile materials.

A document as referred to herein includes one or more pages of printed paper or pages to be printed.

A document production organization can be any organization that produces documents for a fee such as, for example, a print shop, production printing company, or a publishing company.

FIG. 1 is a schematic drawing of the components of an exemplary publishing process. A client 10 has a document job 20 they want to produce. The client 10 may directly approach one or more document production organizations to complete the document job, such as DPO 30. Alternatively, they may approach a production service 25 that in turn contacts one or more document production services such as DPO 30. DPO 30 in turn may have production facilities at multiple locations such as DPO1 . . . DPON 40. DPO 30 then typically uses some sort of pre-flight software to provide information 50 for the job including estimated cost and time of delivery to the production service 25 or directly to the client 10. Regardless, the client 10 will typically want a cost estimate prior to production. Also, in some cases, the client 10 or production service 25 is communicating with multiple document production organizations and will be requesting a bid from DPO 30.

FIG. 2 is a flow chart of an exemplary cost estimation process performed by the recipient(s) of a document production request. It is important to note that the order of the steps as presented here is not necessarily required. A client submits a document production order 100 either directly to a document production organization or to a production service that delivers the order to one or more document production organizations. At this time, the client provides order details regarding the order to be completed. After receiving the order, a document production organization determines what supplies, media, and processing will be required to create and deliver the requested order 110. Based upon any of a variety of constraints, the document production organization generates a plurality of possible workflows to complete the print order 120. For each workflow, the document production organization estimates a cost for completing the print order 130. Finally, a workflow is chosen 140 to complete the print order based at least in part upon the estimated cost for each workflow. The document production organization provides an estimate of the cost of producing the document for the customer based upon the details of the print order and the workflow selected 150. In embodiments, the method further comprises submitting a bid for completion of the work order for the chosen workflow 160. In many cases, the bid submitted would be based upon the workflow that had the lowest overall cost.

When a document production organization receives the details of a job from a client, the document production organization calculates the time and cost of producing the job, and provides an estimate to the client. In many cases, the document production organization may have multiple workflows from which it could choose. The document production organization will typically choose a workflow based upon constraints such as time for completion and/or cost. Job costs are based upon materials used, size of job, etc. To help select an appropriate workflow, and to provide better estimates, especially for the purpose of bidding for a job, a document production organization should include accurate shipping costs for shipping some or all of the print job based upon the materials and resources to be used.

Shipping costs can include the costs of transporting portions of the job from one location to another as well as the costs of transporting the finished job to the client. Facilities in one location may be best equipped to handle one portion of a job, while facilities in another location may be best equipped to handle another portion of a job. Also, copies of a job, such as, for example, a report or manual, may ultimately be sent to recipients in multiple locations. If the document production organization has locations in multiple areas, it may allocate completion of copies of the job to multiple facilities based upon each facility's proximity to a recipient or recipients.

FIG. 3 is a flow chart of an exemplary method for determining the shipping costs for a particular workflow. First, a document production organization receives an order from a client 200. The document production organization then determines the media required to complete the order 210. Generally, pre-flight software is used to determine the amount of media required for a deliverable unit of the order. Next, the weight of the required media is determined 220. The size and weight of a deliverable unit of the order is calculated based on the amount of the media required. In embodiments, this information may be stored in locally or remotely. For example, a database of media (paper, binding, CD, DVD, envelopes, etc) sizes and weights may be used to calculate a print order's completed unit weight and size. Once the weight information is retrieved, the document production organization can check shipping rates 230. Shipping rates are then checked based upon the estimated weight of the required media and its destination address. Updated schedules can be checked for a variety of shipping organizations including, for example, the US Postal Service, United Parcel Service, and Federal Express. Shipping schedules can be updated locally, either electronically or manually, or this information can be retrieved electronically from the shipping organizations themselves. Finally, the transportation costs for that workflow are calculated 240.

In embodiments, for example, shipping costs could be used to determine where the document production order is actually finished and/or where components of the document are completed. As previously discussed, the costs of transporting media can include both delivery of the final product as well as the costs of shipping part or all of the media from one location to another. The shipping costs calculated for each workflow at step 240 would include transportation costs for moving materials between sites, if any, as well as final delivery. This may factor significantly into workflow selection. For example, it may be desirable to have the final product produced in close physical proximity to the client. This would be especially true, for example, where components completed elsewhere could be shipped electronically, at little cost to that final location.

In embodiments, the client may be soliciting bids from multiple document production organizations directly or indirectly through a production service that solicits automatic bids from document production organizations. Typically, in either case, document production organizations that have a facility geographically close to the final destination are solicited. From among them, an algorithm is employed that chooses the organization that best meets the client's requirements. For example, only certain facilities have an integrated print capability to do all of offset-color, digital color, B/W and binding. The algorithm can also take into account the availability of a mail carrier at the earliest time after product finishing occurs. In addition, it also can take into account any reduced costs due to mass production. For example, if a document production organization has a facility that already has an inventory of certain type of paper, toner, and fonts, it can save time to use them at that facility even though it requires a little wait time, rather than to send it to another organization's facility and wait until resources arrive.

FIG. 4 is a flow chart of an exemplary method of soliciting bids from document production services. First, a client creates the details of a document production job to be completed including a physical description of the completed job to be delivered 300. Then the client submits the details of the job to be completed to and solicits bids from multiple document production organizations 310 either directly or indirectly through a production service. The details of the job submitted would include the physical description of the completed job to be delivered. After submission, the client or service receives bids from the multiple document production organizations 320. These bids include prices that take into account the costs of shipping the completed job to its final destination. Finally, based upon the bids received, the client or production service selects a document production organization to use 330, which will often be based at least in part upon the prices of the bids received.

In embodiments, the client, or production service employed by the client, may select a combination of document production organizations to complete a particular job based upon the capabilities of the individual organizations. For example, an end to end document production scenario can include a group of people working on creating the document, another group working on editing, another on layout, another on pre-press activities such as color correction, another group on the printing aspects, another group on wrapping, packaging, shipping; yet other groups on order management, supply chain management, quality assurance, etc. These functions may all be accomplished within one production company, but they may also be accomplished by a combination of document production organizations. Many document production functions can be performed at geographically scattered locations, especially the ones upstream; e.g., the document creation groups working on illustrations, editing, layout, etc. The actual printing, packaging and quality assurance groups could be either located at or near the destination or at a place where the shipping time is minimal. For example, all the above activities except marketing and gaining orders can be done offshore. When shipping time is critical, printing and shipping can be done on-shore, while the rest can be performed over the Internet via many collaboration tools, such as email, VoIP, netconferencing, etc.

In summary, we the foregoing has described methods for workflow selection, cost estimation, bid submission, and bid selection for document production jobs.

While the present invention has been described with reference to specific embodiments thereof, it will be understood that it is not intended to limit the invention to these embodiments. It is intended to encompass alternatives, modifications, and equivalents, including substantial equivalents, similar equivalents, and the like, as may be included within the spirit and scope of the invention. All patent applications, patents and other publications cited herein are incorporated by reference in their entirety.

1. A method, comprising:
receiving print order information;
generating a plurality of possible workflows to complete the print order,
determining what materials and resources will be required to complete the print order;
for each workflow, estimating a cost for completing the print order including estimating costs for shipping some or all of the print job based upon the materials and resources to be used;
choosing a workflow to use to complete the print order based at least in part upon the estimated cost for each workflow.

2. The method of claim 1, further comprising providing a cost estimate for completion of the work order for the chosen workflow.

3. The method of claim 1, further comprising submitting a bid for completion of the work order for the chosen workflow.

4. The method of claim 1, further comprising estimating the weight of any required materials and resources.

5. The method of claim 4, further comprising electronically retrieving cost data from one or more shipping companies, based upon the estimated weight of the required materials.

6. The method of claim 1, wherein determining a workflow includes determining where the physical output of the print order will be produced.

7. The method of claim 1, wherein estimating costs for shipping some or all of the print order includes estimating costs of shipping materials between production locations.

8. The method of claim 1, where the recipient of the print order information is a production service.

9. The method of claim 8, wherein estimating costs for shipping some or all of the print order includes estimating costs of shipping materials between production organizations.

10. A method for generating a bid for a print job, comprising:
receiving the details of a job to be printed;
generating a plurality of possible workflows to complete the print order;
determining the costs of each of the possible workflows,
wherein determining the cost of each workflow includes determining the costs of shipping materials between production sites as well as shipping a finished product;
submitting a bid for the print job based upon a cost of the cheapest of the plurality of possible workflows.

11. The method of claim 10, further comprising estimating the weight of any required materials and resources.

12. The method of claim 11, further comprising electronically retrieving cost data from one or more shipping companies, based upon the estimated weight of the required materials.

13. The method of claim 10, wherein determining the cost of each workflow includes determining where the physical output of the print order will be produced.

14. The method of claim 10, wherein estimating costs for shipping some or all of the print order includes estimating costs of shipping materials between production locations.

15. The method of claim 10, where the recipient of the print order information is a production service.

16. The method of claim 15, wherein generating a plurality of possible workflows includes generating workflows including multiple document production organizations.

17. A method for selecting an organization to complete a document production order, comprising:
creating the details of a document production job to be completed including a physical description of the completed job to be delivered;
submitting the details of the job to be completed to multiple document production organizations, wherein the details of the job include the physical description of the completed job to be delivered;
receiving bids that include prices that take into account the costs of shipping the completed job to its final destination;
selecting an organization based upon the bids received.

18. The method of claim 17, wherein submitting the details of the job to be completed to multiple document production organizations is performed by a production service.

19. The method of claim 17, wherein the bids received also takes into account costs of internally transporting at least some of the job to be completed.
